(19) United States
(12) Patent Application Publication
(10) Pub. No.: US 2009/0292582 A1
(43) Pub. Date: Nov. 26, 2009

(54) SERVICEABILITY SCORING MODEL

(76) Inventors: Rüdiger Ebert, Adelsdorf (DE); Jahn Holger, Hemhofen (DE); Michael Blicks, Unterhaching (DE); Mirko Appel, Munchen (DE)

Correspondence Address: BRINKS HOFER GILSON & LIONE, P.O. BOX 10395, CHICAGO, IL, 60610, US

(21) Appl. No.: 11/860,932

(22) Filed: Sep. 25, 2007

(51) Int. Cl. G06Q 10/00; G06Q 50/00

(52) U.S. Cl. 705/10

(57) ABSTRACT

A system and method relate to generating overall and/or relative serviceability scores for products. The system and method may include (1) adjusting a serviceability scoring model according to a product specific service model and (2) rating serviceability requirements. The adjustment of the scoring model may include (a) weighting serviceability aspects according to the product specific service strategy and/or (b) correlating the weighted serviceability aspects to key performance indicators to generate weighted key performance indicators. The rating of the serviceability requirements may include correlating the weighted key performance indicators to selected and/or weighted serviceability requirements. Each serviceability requirement selected may have a specified level of serviceability to be realized. An overall serviceability score may then be calculated. The score may be adjusted in relation to preceding or competing products. Overall serviceability scores may facilitate engineering and product management decisions, product design/development, and potential customers making more informed business decisions.

### BACKGROUND

The present embodiments relate generally to the serviceability of products. More particularly, the present embodiments relate to determining serviceability scores for products.

Estimated serviceability information regarding a product may be important for product engineering decisions and marketing purposes. Serviceability information on individual products may be used by engineers during the produce definition process. Additionally, serviceability information may be important for the sales or service department of an equipment manufacturer or service provider for a number of reasons. For instance, conventional types of equipment may cost a rather substantial amount of money. As a result, potential customers may want to review serviceability information related to a product before making a business decision.

However, standard serviceability information available to engineers and management/marketing personnel during internal product development and evaluations may be lacking. Insufficient serviceability information may hinder product development. Additionally, typical serviceability information provided to customers may fail to give a true representation of the serviceability of a product.

Typical serviceability information may focus on individual aspects of serviceability, such as installation time, time to repair, or life cycle costs. From the engineer's or customer's perspective, such individual serviceability aspects may be difficult to readily comprehend and of limited or no value. Reviewing information regarding a number of individual serviceability aspects for a product may create confusion during product development or marketing.

As an example, a customer may have no way of readily comprehending which is better: a product with a low rating on a first aspect, a medium rating on a second aspect, and a high rating on a third aspect as compared to another product with a medium rating on the first aspect, a high rating on the second aspect, and a low rating on the third aspect, or other combinations of aspect ratings for different products.

Thus, when making a business decision, if merely presented with a long list of various aspect ratings of a number of potential products that the customer is interested in, the customer may become annoyed. Hence, conventional information regarding serviceability aspects may serve to irritate customers, rather than facilitate informed decision making.

### BRIEF SUMMARY

A system and method relate to developing and adjusting serviceability scores for products. The system and method may include (1) adjusting a serviceability scoring model according to a product specific service model and (2) rating the serviceability requirements of a product. The first step of adjusting the scoring model may include (a) weighting serviceability aspects according to the product specific service strategy, and/or (b) correlating the weighted serviceability aspects to key performance indicators (KPIs) to generate weighted KPIs. The second step of rating the serviceability requirements may include (a) correlating the weighted KPIs to serviceability requirements, (b) the selection of the serviceability requirements to be realized, and/or (c) the specification of the level of realization per serviceability requirement to be realized. An overall serviceability level or score may then be calculated. As a result of the above, serviceability requirements with respect to their service business relevance may be ranked. This may facilitate engineering and product management personnel with prioritization and design of product features, as well as the realization of product servicing budgets. The serviceability score also may be used as an input for product related life cycle cost calculations. Moreover, the results may be shared with potential customers to enable a more informed business or purchasing decision.

In one embodiment, a method derives a level of serviceability for a product. The method includes selecting serviceability design aspects for a product, generating weighted key performance indicators as a function of the selected serviceability design aspects, and selecting serviceability requirements for the product. The method also includes deriving an overall level of serviceability of the product as a function of the weighted key performance indicators and the selected serviceability requirements, and presenting the overall level of serviceability.

In another embodiment, a method derives a level of serviceability for a product. The method includes weighting serviceability aspects for a product according to a product specific service strategy, and correlating the weighted serviceability aspects to key performance indicators to generate weighted key performance indicators. The method also includes generating an overall serviceability score for the product as a function of the correlation of the weighted key performance indicators to serviceability requirements for the product, and displaying the calculated overall serviceability score for the product.

In another embodiment, a data processing system derives a level of serviceability for a product. The system includes a processing unit that (1) adjusts key performance indicators according to weighted serviceability aspects for a product, (2) accepts, retrieves, or otherwise identifies serviceability requirements for the product, (3) calculates an overall serviceability score for the product as a function of the adjusted key performance indicators and the serviceability requirements, and (4) displays the overall serviceability score for the product.

In yet another embodiment, a computer-readable medium provides instructions executable on a computer. The instructions direct weighting key performance indicators in accordance with weighted serviceability related design aspects for a product, and correlating the weighted key performance indicators with serviceability requirements for the product to generate weighted serviceability requirements. The instructions also direct calculating an overall level of realization for the weighted serviceability requirements as an overall serviceability score for the product, and displaying the overall serviceability score on a display.

Advantages will become more apparent to those skilled in the art from the following description of the preferred embodiments which have been shown and described by way of illustration. As will be realized, the system and method are capable of other and different embodiments, and their details are capable of modification in various respects. Accordingly, the drawings and description are to be regarded as illustrative in nature and not as restrictive.

### BRIEF DESCRIPTION OF THE DRAWINGS

FIG. 1 illustrates an exemplary method of deriving an overall level of serviceability for a product;

FIG. 2 illustrates another exemplary method, or portion thereof, of deriving an overall level of serviceability for a product;

FIGS. 3 to 8 illustrate exemplary user interface display screens associated with presenting serviceability scores to the user; and

FIG. 9 illustrates an exemplary data processor configured or adapted to provide the functionality for deriving customer specific and other overall serviceability scores for products.

### DETAILED DESCRIPTION

The embodiments described herein include methods, processes, apparatuses, instructions, systems, or business concepts that relate to a “Serviceability Scoring Model” that generates overall and/or relative serviceability scores for products. The system and method may include (1) adjusting a serviceability scoring model according to a product specific service model and (2) rating the serviceability requirements for the product to generate an overall serviceability score for the product.

The first step of adjusting the scoring model may include (a) weighting serviceability aspects according to a product specific service strategy and/or (b) correlating the weighted serviceability aspects to key performance indicators (KPIs) to create weighted KPIs. The second step of rating the serviceability requirements may include (a) correlation of the weighted KPIs to serviceability requirements, (b) selection of the serviceability requirements desired to be realized, and/or (c) specification of the level of realization per serviceability requirement to be achieved. An overall and/or relative serviceability level/score may then be calculated.

As a result of the above, serviceability requirements with respect to their service business relevance may be ranked. The ranking of the serviceability requirements may be used by engineering and/or product management personnel with during the prioritization and/or the design of product features. The ranking of serviceability requirements also may be used to realize servicing budgets or goals for specific products. In one embodiment, the serviceability score may be used as an input for calculating the life cycle cost of a specific product.

Furthermore, a potential customer may be presented with customer specific and/or overall serviceability scores for a number of related products of a same or similar type for easy comparison of the overall and/or relative serviceability of the products. Therefore, product design, product selection, service plan selection and/or tailoring, financing, and/or other business decisions being made by the customer may be better informed.

A high level of serviceability may have a positive effect on (1) installation time, (2) mean time to repair (MTTR), (3) first time fix rate (FTFR), (4) telephone and remote fix rate, (5) life cycle costs, (6) customer satisfaction (such as end customer and service organization satisfaction), and other factors, including those discussed elsewhere herein. Serviceability may be viewed as a function of all of the above mentioned and/or additional, fewer, or alternate components.

With conventional techniques, there may be no single key performance indicator that adequately reflects the level of serviceability. Merely counting the fulfillment of individual serviceability requirements may not be sufficient for an appropriate evaluation of the achieved serviceability level. The Serviceability Scoring Model discussed herein may provide an overall, relative serviceability score that permits comparison of realization alternatives and also different products. In one aspect, the serviceability scores generated may be relative values, as compared to an absolute classification of the serviceability of the corresponding product. Other serviceability scores may be calculated.

In general, the Serviceability Scoring Model may support methodology and tooling operable to (1) support an objective decision making process by a qualitative assessment and to become the fundamental basis for engineering decisions and/or a financial service plan for a product, (2) permit selection of the serviceability requirements according to service key aspects and business objectives, (3) make it easy to identify the really relevant or most important serviceability requirements (separate the so-called wheat from the chaff), and (4) make the level of serviceability of different products readily comparable.

In one embodiment, the Serviceability Scoring Model may be implemented via one or more software applications and/or tools. For instance, the Serviceability Scoring Model may use a (1) a benchmark tool, (2) a common decision tool, and/or (3) an implementation of a scoring model tool. Other software tools may be used.

The benchmark tool may develop a weighted criteria catalog. The benchmark tool may be used to identify optional and/or mandatory requirements for the Serviceability Scoring Model, weight the requirements, integrate a number of software solutions, such as Excel™ and Access™ based applications, and/or calculate scores.

The common decision tool may be used to generate a decision proposal and used in connection with medical customer service. The common decision tool may be used to consolidate the scoring results and/or select a decision proposal, such as whether to manufacture or buy a product. The common decision tool may be integrated with a final decision tool, such as Qualica QFD™ or another software application.

The implementation of the scoring model may be implemented by customizing and/or integrating other tools. For instance, the implementation may involve the importation of Excel™ data into Qualica QFD™. The implementation may involve defining and integrating import/export interfaces for engineering process requirements to be used in cooperation with medical customer service. The implementation also may include the installation and usage of the tools in a medical customer service environment. The Serviceability Scoring Model may involve other aspects, including those discussed elsewhere herein.

The Model may involve tailoring the serviceability aspects and/or serviceability requirements according to a specific product or customer. Customers may range from individuals or small organizations to large organizations. As a result, each customer's business and/or financial wants and needs may be different. The Model may facilitate the comparison of different levels of serviceability over a range of different, but related, products. The Model may permit finding a product with an appropriate level of serviceability related to a business model. As an example, for a specific business model, certain serviceability aspects may be more or less important. KPIs may be weighted in accordance with the serviceability aspects of the business model to provide a level of importance of each KPI for a particular product and/or customer. Subsequently, serviceability requirements may be correlated with the weighted KPIs to create weighted serviceability requirements and generate an overall and/or relative serviceability score.

### I. Exemplary Serviceability Scoring Model

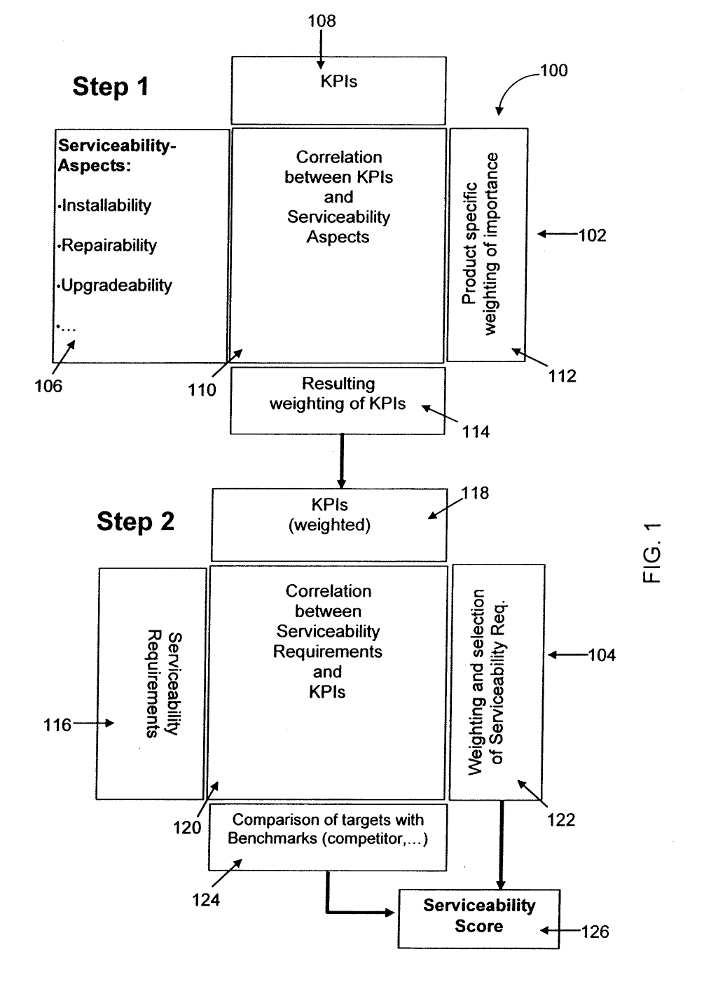

FIG. 1 illustrates an exemplary method of deriving an overall level of serviceability for a product 100. The method 100 may include a first step 102 associated with adjusting a serviceability scoring model according to a product specific service model and a second step 104 associated with rating the serviceability requirements of the product. The method 100 may generate an overall and/or relative serviceability score 126. The method may include additional, fewer, or alternate steps.

A. First Step

The first step of adjusting the serviceability scoring model 102 may include weighting serviceability aspects according to the product specific service strategy 106 and/or correlating 110 the weighted serviceability aspects 106 to key performance indicators (KPIs) 108 to achieve product specific weighting of serviceability aspect importance 112 and generate weighted KPIs 114. The first step may include additional, fewer, or alternate actions.

It should be noted that key performance indicators, as the term is used herein, may relate to statistical or other measures that are in part monitored by software tools. Each key performance indicator may be directed to specific or general topics pertinent to serviceability. Each key performance indicator may be structured to have one or more virtual dimensions that may have corresponding information accessible via a user interface. Other key performance indicators may be used, including those discussed elsewhere herein.

The first step may be related to the design of a product specific service concept. The specific service strategy may account for engineering or other development concerns or limitations, service business restrictions, and/or customer specifications associated with the product, including financial and/or business models tailored to satisfy the customer. As an example, the group of the serviceability aspects selected and/or weighted may comprise, reflect, or be based upon the product specific service strategy for the product.

The design of the product specific service strategy may include selecting and/or weighting serviceability aspects for one or more products. The objective of which may be to obtain weighted KPIs based on the service strategy for a product by weighting serviceability aspects regarding customer specific service requirements and initial service concept. Accordingly, the first step may include reviewing and/or updating the weighting of serviceability aspects and/or reviewing the resulting impact of the KPIs on serviceability. A project manager, design engineer, serviceability specialist, sales person, customer, and/or others may be involved with the selection and/or weighting of the serviceability aspects.

Table I below illustrates exemplary serviceability aspects for a product. As shown, the serviceability aspects may include design for reliability, repair, usability/trainability, maintainability, documentation, updateability, upgradeability, enhanced productivity services, safety, installability, and decommissioning/deinstallation. The serviceability aspects may be serviceability design aspects associated with the design, manufacture, maintenance, and/or service of the product. Additional, fewer, or alternate serviceability aspects may be used.

TABLE I
Serviceability Aspects

| Serviceability Aspects | Weight |
|---|---|
| Design for Reliability | 9 |
| Design for Repair | 9 |
| Design for Usability/ | 9 |
| Trainability | |
| Design for Maintainability | 6 |
| Design for Documentation | 8 |
| Design for Updateability | 6 |
| Design for Upgradeability | 6 |
| Design for Enhanced | 9 |
| Productivity Services | |
| Design for Safety | 9 |
| Design for Installability | 6 |
| Design for Decommissioning/ | 5 |
| Deinstall | |

As shown in Table I, the serviceability aspects may be weighted. For instance, the design for reliability, repair, usability/trainability, enhanced productivity services, and safety aspects are weighted as a “9.” The design for documentation aspect is weighted as an “8.” The design for maintainability, updateability, upgradeable, and installability aspects may be weighted as a “6.” The design for decommissioning/deinstallation aspect may be weighted as a “5.” Additional, fewer, or alternate serviceability aspects and/or weightings may be used.

The aspects may be weighted relative to one another. Absolute weightings may be used. The aspects may be weighted by a product manufacturer or a potential end-user. The aspects may be weighted in accordance with a product specific service strategy or other business model. Other types of weightings may be performed.

B. Second Step

The second step of rating the serviceability requirements 104 may include correlating 120 the weighted KPIs 118 to serviceability requirements 116. The second step 104 may include weighting and/or selecting the serviceability requirements to be realized 122, comparison of target products with benchmarks 124, and calculating serviceability scores 126. The second step may include additional, fewer, or alternative actions.

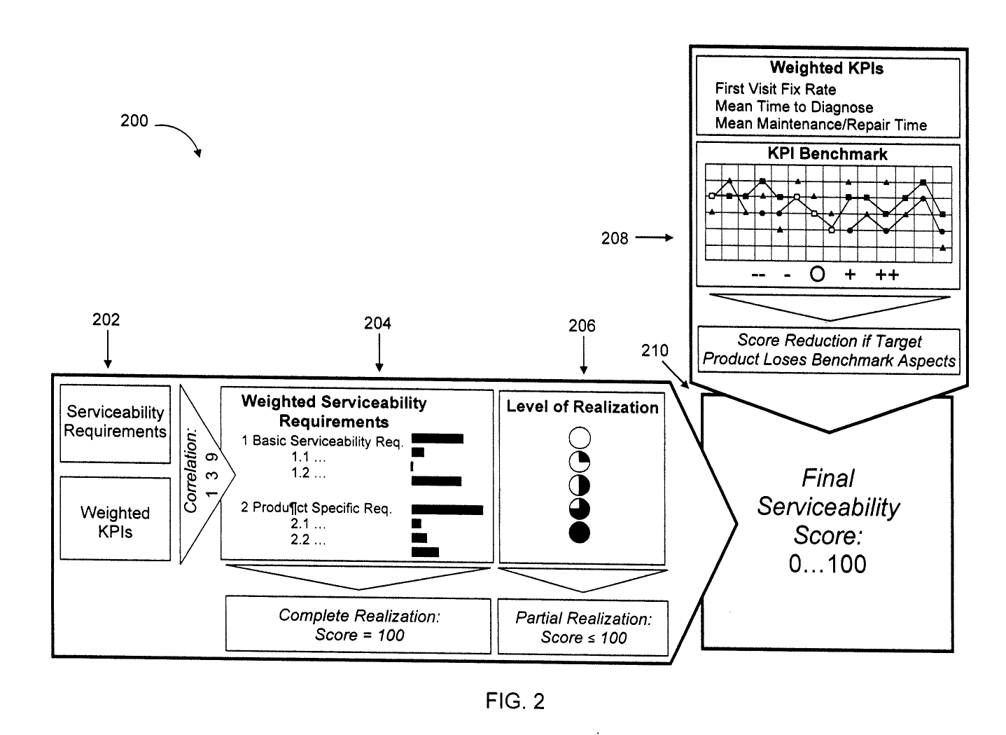

FIG. 2 illustrates another exemplary step of rating the serviceability requirements 200. The serviceability requirements and weighted KPIs may be correlated 202. The correlation of the serviceability requirements and the weighted KPIs (weighted by correlation to serviceability design aspects) 202 may lead to the creation of weighted serviceability requirements 204. Each weighted serviceability requirement may receive a weight of 1 (least level of correlation), 3 (medium level of correlation), or 9 (highest level of correlation). Additional, fewer, or alternate levels of correlation and/or numeric correlation values may be used.

The weighted serviceability requirements 204 may be arranged by group or sub-groups. The weighted serviceability requirements may relate to basic serviceability requirements, product specific requirements, and/or other requirements. The weight of each requirement may represent its relative or absolute importance according to product specific design aspects. Assuming all serviceability requirements are realized, a maximum “serviceability score” of 100 may be reached, i.e., complete realization of the weighted serviceability requirements for a product may produce a score of 100. Other scoring ranges may be used.

A level of realization for each of the weighted serviceability requirements may be determined and displayed 206. After which, an overall level of realization may be calculated from the individual levels of realization for each serviceability requirement. The overall or composite level of realization may account for all of the weighted serviceability requirements.

The serviceability score mentioned above may be based upon the realization level of the weighted serviceability requirements. The serviceability requirements with larger weights may influence the score more than the serviceability requirements with smaller weights. In one aspect, a partial realization of the weighted serviceability requirements may yield a score of less than 100. The level of realization may be displayed graphically as a pie chart, such as a full pie equals a score of 100, a half pie equals a score of 50, a quarter pie equals a score of 25, and so on.

As shown in FIG. 2, adjustments to a preliminary serviceability score and/or the overall level of realization may be made 208. As an example, the weighted KPIs may be compared with one or more related KPI benchmarks. The score may be reduced if a target product or other product being analyzed loses when compared to the benchmarked serviceability. On the other hand, the score may be increased if the target product beats the benchmarked serviceability. A final serviceability score may be produced and presented 210, such as on a display or printout.

1. Creating Weighted Serviceability Requirements

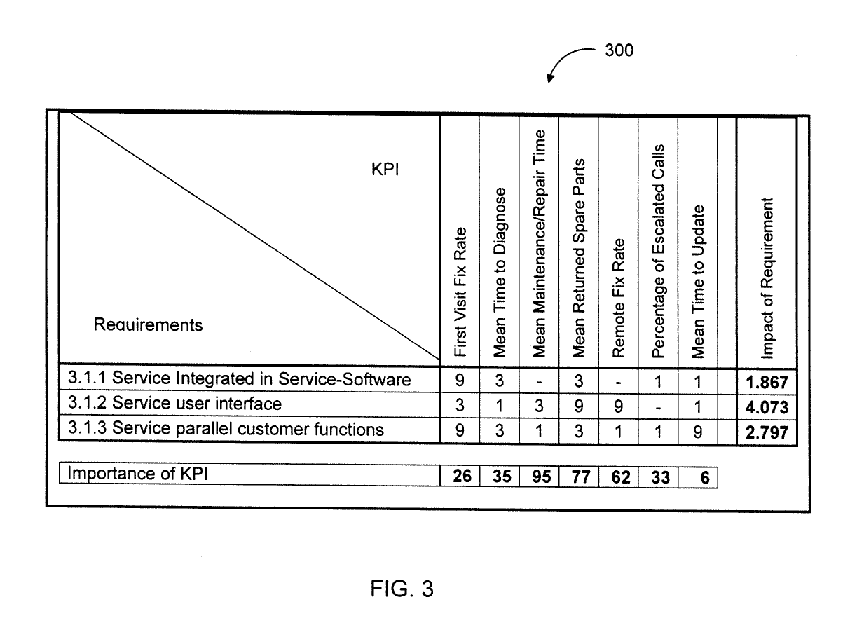

The serviceability requirements and weighted KPIs may be correlated to create weighted serviceability requirements. FIG. 3 illustrates an exemplary display screen 300 associated with the correlation of weighted KPIs to serviceability requirements. FIG. 3 shows a number of weighted KPIs, such as First Visit Fix Rate, Mean Time to Diagnosis, Mean Maintenance/Repair Time, Mean Returned Spare Parts, Remote Fix Rate, Percentage of Escalated Calls, and Mean Time to Update. Additional, fewer, or alternate weighted KPIs may be used.

The serviceability requirements shown relate to service integrated in service-software, service user interface, and service parallel customer functions. Additional, fewer, or alternate serviceability requirements may be used, including those discussed herein.

An Impact of Requirement number may be calculated and displayed for each serviceability requirement to help a user identify the most important requirements on the score. The Impact of Requirement may be related to the impact that a serviceability requirement has upon the serviceability score and/or achieving the product specific service strategy. As an example, the higher the Impact of Requirement number, the more impact that serviceability requirement has upon the overall serviceability.

An Importance of KPI number may be calculated and displayed for each weighted KPI to show the impact of each respective KPI in relationship to the serviceability score and/or product specific service strategy. As an example, the higher the Importance of KPI number, the more impact that weighted KPI has upon the overall serviceability.

In one aspect, four levels of correlation between weighted KPIs and serviceability requirements may be used: 0=no correlation; 1=weak correlation; 3=medium correlation; and 9=strong correlation. The impact/weight numbers to be presented to a user for each serviceability requirement may be the sum of or otherwise related to the correlations (impact) and KPI importance (weight). In one embodiment, as shown in FIG. 3, the “Impact of Requirement” for each requirement is the weighted sum of the correlations for each requirement, where the weight of each correlation is the associated KPI importance. Alternatively, a serviceability requirements' weight may depend on the rating of a corresponding serviceability aspect. Other impacts and/or weights may be calculated and presented.

2. Level of Realization

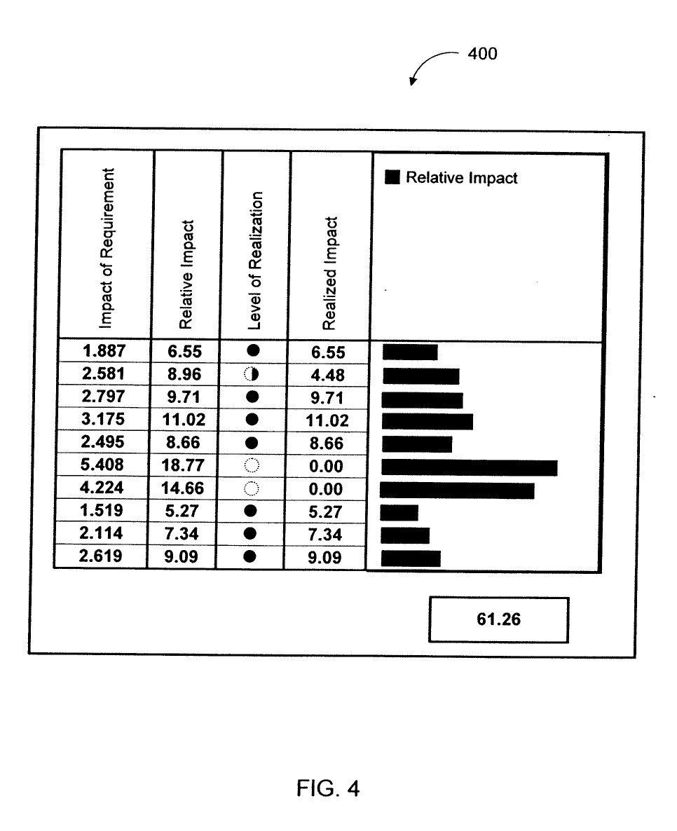

The level of realization of a desired serviceability requirement that a product actually meets may be calculated and displayed. FIG. 4 illustrates an exemplary display screen or portion thereof 400 associated with presenting realization levels and various impacts. The level of realization may be characterized as a “grade” of implementation. In one aspect, only full implementation of all serviceability requirements may result in a score of 100. FIG. 4 shows the “impact of requirement,” “relative impact,” “level of realization,” and “realized impact” portion of a display screen. The impact of requirement is mentioned above and may be related to the impact that a serviceability requirement has upon the serviceability score and/or achieving the product specific service strategy. The relative impact of each serviceability requirement may be determined and displayed for easy comparison of serviceability requirements. The level of realization may represent a level of realization for individual serviceability requirements and/or an indication of the impact a serviceability requirement has on the score. The relative impact may show the relative importance of the serviceability requirement on the score. Other definitions for the impact of requirement, relative impact, level of realization, and realized impact may be used.

A number of realization levels may be used, such as levels related to a serviceability requirement (1) not being implemented or achieved at all by a product, (2) a 25% realization, (3) a 50% realization, (4) a 75% realization, and (5) a 100% realization. Each level of realization used may have its own dedicated icon for easy recognition via the display. Additionally, special requirements and/or levels of realization may be used. For instance, certain requirements may be mandatory or must be implemented due to legal and/or safety regulations. Other serviceability requirements may be used.

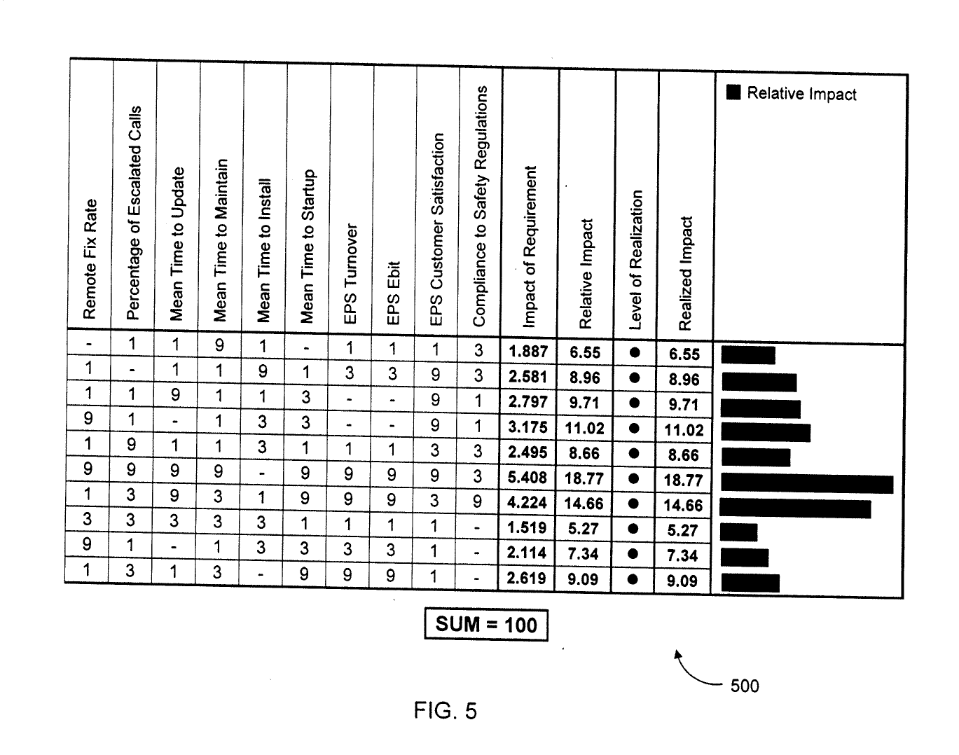

In one embodiment, the weight of each serviceability requirement represents its importance according to product specific design aspects. FIG. 5 illustrates an exemplary user interface screen or portion thereof 500 that illustrates that concepts discussed above with respect to FIGS. 3 and 4 may be combined. As shown in FIG. 5, assuming all serviceability requirements are fully realized, a maximum score of 100 may be reached. The impact/weight numbers to be presented to a user for each serviceability requirement, such as the “6.55” shown in the first row, may depend on the importance of a KPI associated with the serviceability requirement. As shown in FIG. 5, the realization impact numbers may be relative numbers, and may total approximately 100. Alternatively, the sum of the correlations for a serviceability requirement may be determined and displayed. Additional, fewer, or alternate relative and realized impact and/or weight indicators may be calculated and presented.

It should be noted that in a preferred embodiment there is no direct correspondence between serviceability aspects and serviceability requirements. Rather the aspects and requirements are coupled via the KPIs (such as with FIG. 1 and the associated discussion). The importance of a KPI may be adjusted by the correlation of that KPI with a weighted serviceability aspect. Subsequently, the weighted KPI may be correlated with a serviceability requirement to determine the realized extent of that serviceability requirement or the impact of that requirement on an overall serviceability score.

3. Benchmarking

A target product or other product being analyzed may have associated KPIs that are classified with respect to predecessor(s) and/or competitor(s). The target product's KPIs which are classified worse than a predecessor or competitor product may cause serviceability score reduction. Larger KPI weight may lead to a larger score reduction. Alternatively, the target product's KPIs which are classified better than a predecessor or competitor product may cause the serviceability score to increase. Larger KPI weight may lead to a larger score increase.

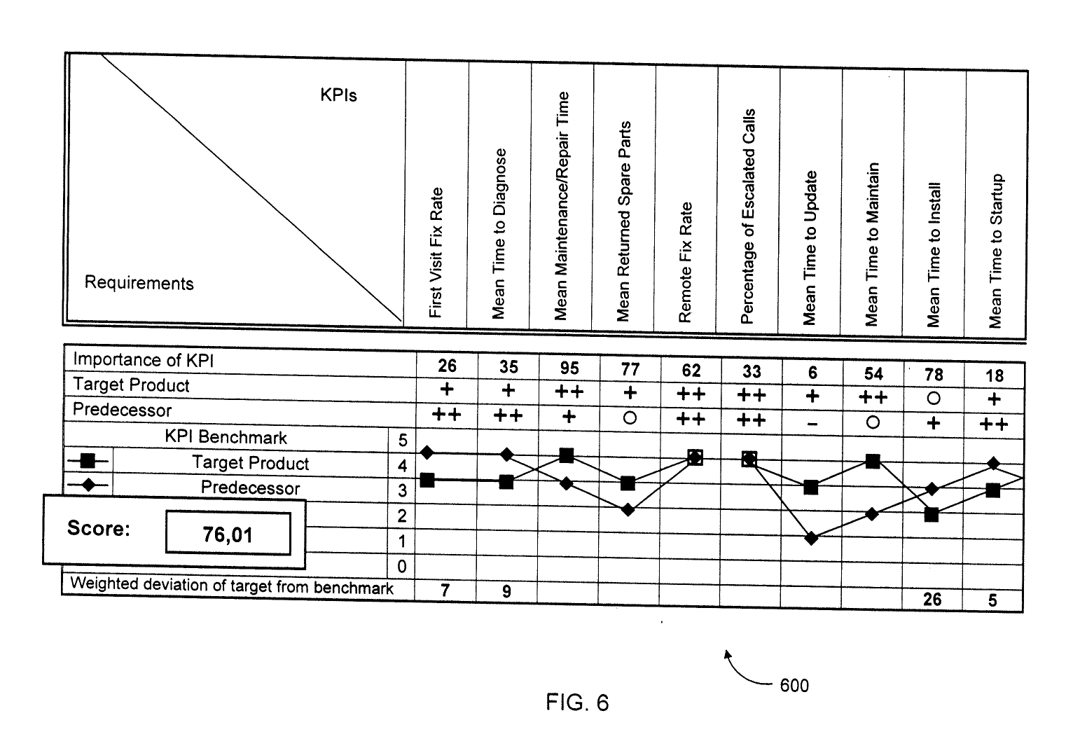

FIG. 6 illustrates an exemplary user interface screen 600 that presents a graphical comparison of a target product with a predecessor product. Similar graphical comparisons may be made between a target product and a competitor's product. As shown, for each weighted KPI, a target product and either a predecessor or competing product may be compared and displayed.

4. Defining Serviceability Requirements

Before correlating the serviceability requirements and the weighted KPIs, the serviceability requirements may be defined. The serviceability requirements may be defined as either product independent, i.e., general, basic serviceability requirements, or product specific serviceability requirements, or a combination thereof. In one embodiment, product specific serviceability requirements may be identified. The product specific serviceability requirements may be correlated to pre-defined KPIs. The correlations may be reviewed and updated, as well as correlations among the serviceability requirements. A project manager, design engineer, serviceability specialist, sales person, customer, or others may participate in the process of defining the serviceability requirements.

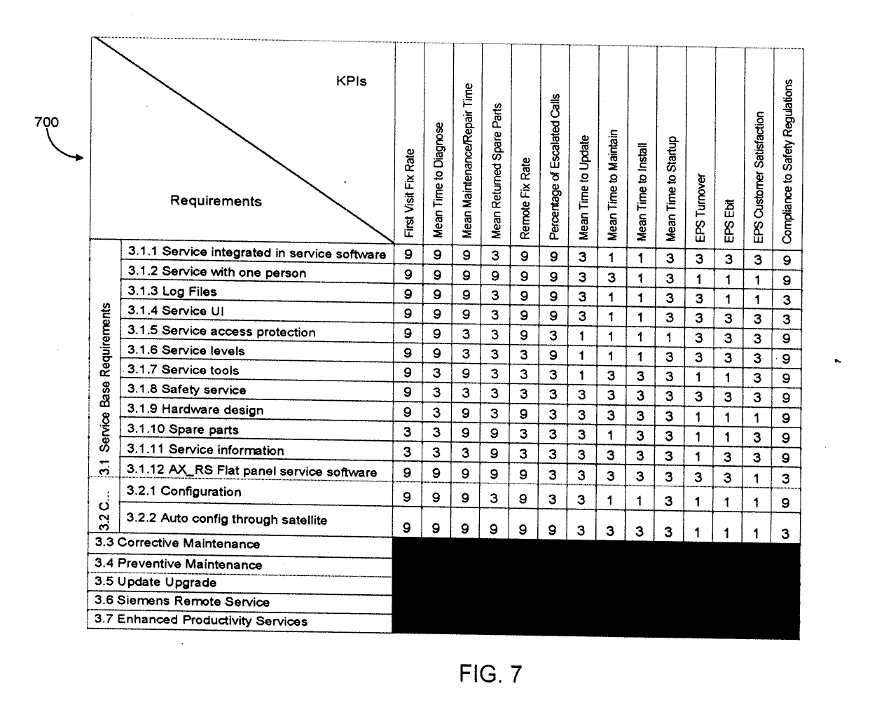

FIG. 7 illustrates an exemplary user interface screen 700 showing exemplary serviceability requirements. FIG. 7 shows a number of weighted KPI's across the top of the display screen. The weighted KPIs include key performance indicators related to First Visit Fix Rate, Mean Time to Diagnose, Mean Maintenance/Repair Time, Mean Returned Spare Parts, Remote Fix Rate, Percentage of Escalated Calls, Mean Time to Update, Mean Time to Maintain, Mean Time to Install, Mean Time to Startup, Enhanced Productivity Service (EPS) Turnover, EPS Ebit (earnings before interest and taxes), EPS Customer Satisfaction, and Compliance to Safety Regulations. Additional, fewer, or alternative weighted KPIs may be used.

FIG. 7 also shows a number of serviceability requirements. The serviceability requirements shown may be separated into product specific serviceability requirements and general or product independent serviceability requirements. The basic serviceability requirements shown may be product independent and/or may relate to service integrated with service software, service with one person, log files, service user interface, service access protection, service levels, service tools, safety service, hardware design, spare parts, service information, and/or flat panel service software serviceability requirements.

As shown in FIG. 7, product specific serviceability requirements also may be shown. The serviceability requirements may relate to configuration, automatic configurations via satellites, corrective maintenance, preventive maintenance, updates and/or upgrades, remote service, and/or enhanced product services. Additional, fewer, or alternate serviceability requirements may be defined.

5. Optimizing Scoring Level

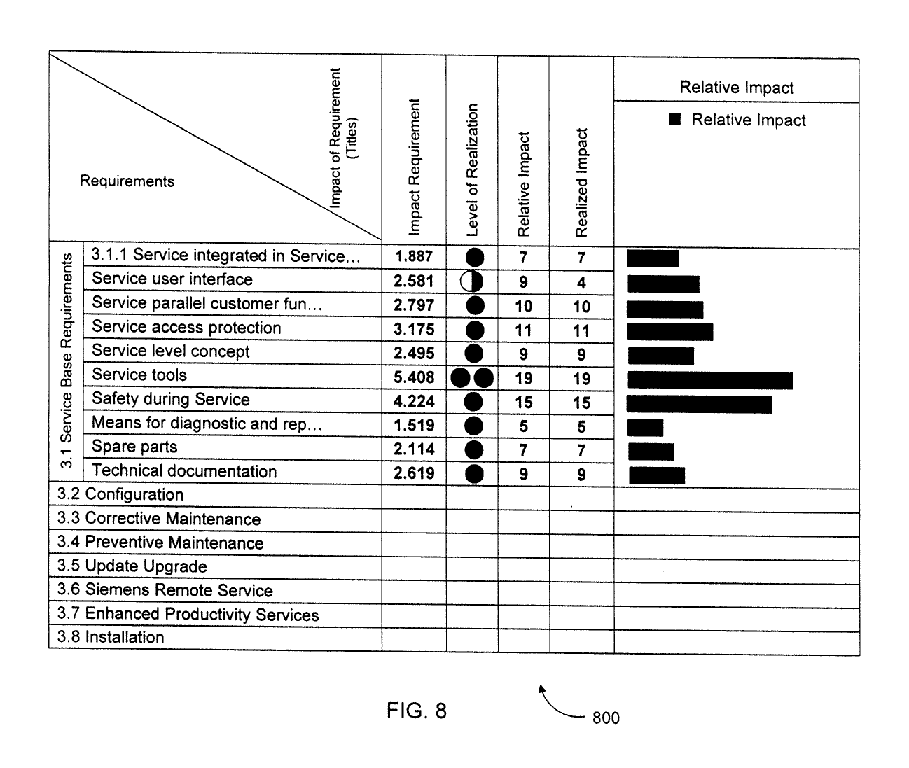

Defining the serviceability requirements may include optimizing the score, individual levels of realization of the serviceability requirements, and/or an overall level of realization. FIG. 8 illustrates an exemplary user interface screen 800 associated with optimization. The identification of an optimal set of serviceability requirements to be realized may be selected based upon their impact, such as their relative or other impact on the overall serviceability score.

As shown in FIG. 8, the impact of each serviceability requirement on the score may be calculated and graphically displayed. The impact on the overall score, level of realization, relative impact, and realized impact of each serviceability requirement may be calculated and presented. The serviceability requirements may include service integration, service user interface, service parallel customer, service access protection, service level concept, service tools, safety during service, means for diagnostic testing and repair, spare parts, and technical documentation requirements. The serviceability requirements may include configuration, corrective maintenance, preventive maintenance, updates and upgrades, remote service, enhanced productivity services, and installation related requirements. Additional, fewer, or alternate requirements may be used.

In one aspect, defining the serviceability requirements may include (1) identification of mandatory serviceability requirements and/or (2) selection of a level of realization for each serviceability requirement. The selected level of realization may be based upon the impact of the serviceability requirements on the serviceability score. The correlation between the serviceability requirements and/or their relative impacts may be reviewed. Subsequently, steps (1) and (2) identified above may be repeated to further tailor or optimize the results.

Table II below illustrates possible scoring activities and process steps related to the embodiments discussed herein.

TABLE II
Overview of Possible Scoring Activities Within Process Steps

| Process Step | Scoring activity | Remarks |
|---|---|---|
| Develop | Correlate | Generation and maintenance of product |
| Serviceability | Serviceability | independent serviceability aspects, KPIs |
| Strategy | Aspects <−> KPIs | and their correlation based on the service |
| | | roadmap and serviceability strategy |
| | Correlate | Generation and maintenance of product |
| | Requirements <−> | independent basic serviceability |
| | KPIs | requirements and their correlation to the |
| | | defined KPIs based on the service |
| | | roadmap and serviceability strategy |
| | Correlate | Generation and maintenance of product |
| | Requirements | independent correlation of basic |
| | | serviceability requirements between each |
| | | other |
| Design the | Weight | Obtain final weighted KPI based on the |
| Product | Serviceability | service strategy for a product by weighting |
| Specific Service | Aspects | serviceability aspect regarding customer |
| Concept | | specific service requirements and initial |
| | | service concept |
| Define the | Correlate | Completion of product independent basic |
| Serviceability | Requirements <−> | serviceability requirements with product |
| Requirements | KPIs | specific serviceability requirements and |
| | | their correlation to the defined KPIs |
| | Optimize Scoring | Identification of an optimal set of |
| | Level | serviceability requirements to be realized |
| | | based on their impact |

### II. Exemplary Design Aspects and KPIs

The design for supportability may apply to aspects of a product's design that affect the extent, type, timing, ability, and nature of support that customers require once they acquire a product. In one embodiment, the aspects may include Design for Installability, Design for Usability/Training, Design for Documentation, Design for Maintenance, Design for Reliability, Design for Repair, Design for Updateability, Design for Upgradeability, Design for Decommissioning and Replacement, Design for Enhanced Productivity Services (EPS), and Design for Safety.

One aspect may be the Design for Installability aspect. Installability may be defined as the impact of the product design on the ease and cost of installing hardware and software, configuration, implementation, and/or customization to meet the customer's needs. The Design for Installability aspect may include a number of analysis metrics related to labor, time, and cost required, resources required, total installation time, equipment required, material costs, customer resources, and percentage of trouble free installations.

Another aspect may be the Design for Usability/Training aspect. Usability may be defined as the ease with which a product can be used for its most typical tasks. It may cover both the physical usability (ergonomics, etc.) and also the technical usability (ease of completing particular tasks using hardware or software controls). Trainability may be defined as the impact of the design on the ease of training typical users to operate the most frequently used functions. The Design for Usability/Training aspect may include analysis metrics related to customer's learning time required, resources required for training, time to conduct training, number of steps required for most common tasks, time for novice users to learn to conduct the most common tasks efficiently, and frequency of problems per customer.

Another aspect may be the Design for Documentation aspect. Documentation may be defined as any form of information, in whatever media, that is relevant to the installation, use, maintenance, repair, updating, upgrading, and decommissioning of products. The Design for Documentation aspect may include analysis metrics related to total volume of documentation required, online information, text readability scores, ease of access, effectiveness/number of documentation clarification calls, creation cost, and production cost.

Another aspect may be the Design for Maintenance aspect. Maintainability may be defined as the impact of the product design on the ease of cleaning, conducting performance checks, and replacing parts or components to prevent a failure. The Design for Maintenance aspect may include analysis metrics related to time to clean the product, time period between cleanings, preventive maintenance interval, resources required, equipment cost, remote maintenance, and material cost.

Another aspect may be the Design for Reliability aspect. Reliability may be defined as the quality of the product design that makes repairs less frequent. Alternatively, reliability may be defined as the quality of the product design that facilitates high product availability. The Design for Reliability aspect may include analysis metrics related to mean time between failures and redundancy.

Another aspect may be the Design for Repair aspect. Repairability may be defined as the quality of the product design that makes repairs easy and cost-efficient through good diagnostics (such as facilitating preventive actions) and easily or remotely accessible subsystems and components or parts. The Design for Repair aspect may include analysis metrics related to diagnostics hit rate, remote diagnostics, repair time, first time fix rate, resources required, call duration, parts costs, tools/equipment required, and customer costs.

Another aspect may be the Design for Updateability aspect. Updateability may be defined as the quality of the product design that enables updates (such as software patches for fault correction) to be carried out quickly and efficiently. The Design for Updateability may include analysis metrics related to time required, downtime, frequency, resources required, equipment required, material costs, customer costs, and training costs.

Another aspect may be the Design for Upgradeability aspect. Upgradeability may be defined as the quality of the product design that enables enhancements (such as extensions of functionality) to be carried out quickly and efficiently. The Design for Upgradeability may include analysis metrics related to time required, downtime, frequency, resources required, equipment required, material costs, customer costs, and training costs.

Another aspect may be the Design for Decommissioning and Replacement aspect. Decommissionability may be defined as the quality of the product design that allows it to be quickly and easily removed from service with minimal disruption of the customer's operation. It may also include product design that allows cost efficient dismantling and cost efficient disposal with respect to legal requirements (such as environmental laws). The Design for Decommissioning and Replacement aspect may include analysis metrics related to time to migrate, migration effort, ease of migration, and environmental issues.

Another aspect may be the Design for Enhanced Productivity Services (EPS) aspect. EPS may be defined as the quality of the product design that enables productivity services to be carried out efficiently (such as interfaces for remote service, diagnostic tools, etc.).

Another aspect may be the Design for Safety aspect. Safety may be defined as the quality of the product design that facilitates safe operation and service. The design aspect is likely to be subject to safety standards and legal requirements. The Design for Safety aspect may include analysis metrics related to compliance with laws and regulations.

The embodiments discussed herein may include a number of Service Key Performance Indicators. To measure the performance and quality of services the Service Key Performance Indicators (KPIs) are defined. The actual Service KPI values may be stored in an installed product base. The Service KPIs may be designed in conjunction with the serviceability criteria design aspects discussed above.

The Service Key Performance Indicators may include a First Visit Fix Rate KPI that is defined as a rate of (service performing) fixes within first on-site solution attempts. A Downtime Avoidance KPI may be defined as avoidance of downtime through pro-active monitoring and follow-up repair and service activities. A Mean Maintenance/Repair Time KPI may be defined as the time needed of a customer service engineer for corrective maintenance on-site. This may include “time to diagnose.” A Remote Fix Rate KPI may be defined as an amount of problems solved during remote clarification. “Remote” means that no customer service engineer (whether own employee or not) is sent on site to resolve a problem. The distribution of physical goods may not be considered to be “remote.”

A Mean Returned Spare Parts KPI may be defined as a rate of spare parts returned that were not used during on-site repair/maintenance, i.e., troubleshooting parts. A Percentage of Escalated Calls KPI may be defined as a percentage of calls that need to be escalated from an initial or first level of customer support to more involved, second level of customer support. A Mean Time to Maintain KPI may be defined as the time needed for preventive maintenance of the complete system per year. A Mean Time to Update KPI may be defined as a time needed for an on-site software update. This may include pre- and post activities, such as like parameter transformation and backup/restore of site specific data. A Mean Time to Install KPI may be defined as a time needed for on-site installation, and may not include startup time. A Mean Time to Startup KPI may be defined as a time needed to startup the system after the mechanical and electrical installation is completed.

### III. Exemplary Data Processing System

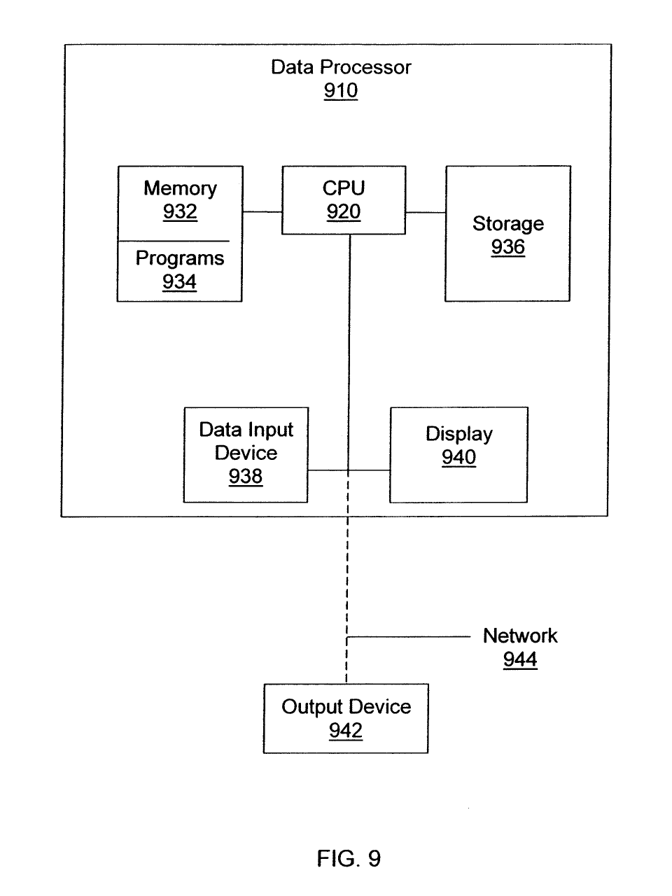

FIG. 9 illustrates an exemplary data processor 910 configured or adapted to provide the functionality for calculating serviceability scores as discussed herein. The data processor 910 may be located at a central location. The data processor may include a central processing unit (CPU) 920, a memory 932, a storage device 936, a data input device 938, and a display 940. The processor 910 also may have an external output device 942, which may be a display, a monitor, a printer or a communications port. The processor 910 may be a personal computer, work station, or customer system, processor, or work station. The processor 910 may be interconnected to a network 944, such as an intranet, the Internet, or an intranet connected to the Internet. The processor 910 may be interconnected to a customer system or a remote location via the network 944. The data processor 910 is provided for descriptive purposes and is not intended to limit the scope of the present system. The processor may have additional, fewer, or alternate components.

A program 934 may reside on the memory 932 and include one or more sequences of executable code or coded instructions that are executed by the CPU 920. The program 934 may be loaded into the memory 932 from the storage device 936. The CPU 920 may execute one or more sequences of instructions of the program 934 to process data. Data may be input to the data processor 910 with the data input device 938 and/or received from the network 944 or customer system. The program 934 may interface the data input device 938 and/or the network 944 or customer system for the input of data. Data processed by the data processor 910 may be provided as an output to the display 940, the external output device 942, the network 944, the customer system, and/or stored in a database.

The program 934 and other data may be stored on or read from machine-readable medium, including secondary storage devices such as hard disks, floppy disks, CD-ROMS, and DVDs; electromagnetic signals; or other forms of machine readable medium, either currently known or later developed. The program 934, memory 932, and other data may comprise and store a database related to serviceability aspect, serviceability requirement, and key performance indicator information.

The data processor 910 may be operable to derive a level of serviceability for a product that accounts for (1) a business model of the product and (2) design aspects of the product, and then present a composite level of serviceability as a serviceability score. In one embodiment, the processor may (1) adjust a serviceability scoring model according to a product specific service strategy for the product, (2) rate serviceability requirements for the product, (3) calculate an overall serviceability level of the product, and (4) present the serviceability level of the product. For example, the processing unit may adjust key performance indicators according to weighted serviceability aspects for a product; accept, retrieve, or otherwise identify serviceability requirements for the product; calculate an overall serviceability score for the product as a function of the adjusted key performance indicators and the serviceability requirements, and display the overall and/or relative serviceability score for the product.

The program or other software associated with the data processor system may include instructions that direct adjusting a serviceability scoring model for a product according to a specific service strategy for the product and rating serviceability requirements to be realized. The instructions also direct calculating an overall serviceability level for the product using the adjusted serviceability scoring model and the rated serviceability requirements. As an example, in one embodiment, a computer-readable medium provides instructions executable on the data processor system or other computer. The instructions direct weighting key performance indicators in accordance with weighted serviceability related design aspects for a product and correlating the weighted key performance indicators with serviceability requirements for the products to generate weighted serviceability requirements. The instructions also direct (a) calculating individual levels of realization for the weighted serviceability requirements, (b) determining an overall level of realization for the weighted serviceability requirements as an overall serviceability score for the product, and (c) displaying the overall serviceability score on a display.

### IV. Exemplary Products and Services

In one aspect, the present embodiments are related to the medical field and the customer locations may be hospitals, clinics, individual health care providers or physicians, or other medical facilities. The customer personnel may include doctors, nurses, and other medical personnel. The products designed and serviced may be medical equipment that assists the medical personnel with the diagnosis of medical conditions and the treatment of patients.

The medical equipment may relate to processing images illustrating an enhanced region of interest within a patient. For example, various types of contrast medium may be administered to a medical patient. The contrast mediums enhance the scans acquired by scanning a patient or images of the patient, the scans and images may be recorded by an external recording device as enhancement data. The contrast medium typically travels through a portion of the body, such as in the blood stream, and reaches an area that medical personnel are interested in analyzing. While the contrast medium is traveling through or collected within a region of interest, a series of scans or images of the region of interest of the patient may be recorded for processing and display by the software applications. The enhanced region of interest may show the brain, the abdomen, the heart, the liver, a lung, a breast, the head, a limb or any other body area.

The expected enhancement data may be generated for one or more specific type of image processes that are used to produce the images or scans of the patient. In general, the types of imaging processes performed by the medical equipment being used to produce patient images or scans of internal regions of interest include radiography, angioplasty, computerized tomography, ultrasound and magnetic resonance imaging (MRI). Additional types of imaging processes may performed by the medical equipment, such as perfusion and diffusion weighted MRI, cardiac computed tomography, computerized axial tomographic scan, electron-beam computed tomography, radionuclide imaging, radionuclide angiography, single photon emission computed tomography (SPECT), cardiac positron emission tomography (PET), digital cardiac angiography (DSA), and digital subtraction angiography (DSA). Alternate imaging processes may be used.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A method of deriving a level of serviceability for a product, the method comprising:
selecting serviceability design aspects for a product;
generating weighted key performance indicators as a function of the selected serviceability design aspects;
selecting serviceability requirements for the product;
deriving an overall level of serviceability of the product as a function of the weighted key performance indicators and the selected serviceability requirements; and
presenting the overall level of serviceability.

2. The method of claim 1, the method comprising weighting the serviceability design aspects in accordance with a product specific service strategy for the product.

3. The method of claim 1, the overall level of serviceability comprising a relative serviceability score among a number of similar products that permits comparison between the number of similar products.

4. The method of claim 1, the method comprising adjusting the overall level of serviceability to account for preceding or competing products.

5. The method of claim 1, the method comprising specifying a relative level that each serviceability requirement is to realize.

6. The method of claim 1, the overall level of serviceability accounting for life cycle of the product, installation time, maintainability, and repairability of the product.

7. The method of claim 1, wherein the product is a medical imaging device.

8. A method of deriving a level of serviceability for a product, the method comprising:
weighting serviceability aspects for a product according to a product specific service strategy;
correlating the weighted serviceability aspects to key performance indicators to generate weighted key performance indicators;
generating an overall serviceability score for the product as a function of the correlation of the weighted key performance indicators to serviceability requirements for the product; and
displaying the calculated overall serviceability score for the product.

9. The method of claim 8, the method comprising specifying a level that each serviceability requirement is to realize.

10. The method of claim 8, the method comprising comparison of the serviceability score for the product with benchmark scores related to preceding products or competing products.

11. The method of claim 8, the method comprising calculating and displaying an impact that a key performance indicator has on a serviceability requirement for the product.

12. The method of claim 8, the method comprising calculating and displaying the relative importance of a key performance indicator on the product specific service strategy or other business model.

13. The method of claim 8, the product being a medical imaging device.

14. A data processing system for deriving a level of serviceability for a product, the system comprising:
a processing unit that (1) adjusts key performance indicators according to weighted serviceability aspects for a product, (2) accepts, retrieves, or otherwise identifies serviceability requirements for the product, (3) calculates an overall serviceability score for the product as a function of the adjusted key performance indicators and the serviceability requirements, and (4) displays the overall serviceability score for the product.

15. The system of claim 14, the processor weighting the serviceability aspects according to a product specific service strategy for the product.

16. The system of claim 14, the processor visually depicting a level of realization for each serviceability requirement.

17. The system of claim 14, the processor calculating and displaying the relative impact that each serviceability requirement has on the overall serviceability score.

18. The system of claim 14, the processor adjusting the overall serviceability score for the product based upon benchmarks associated with predecessor or competing products.

19. A computer-readable medium having instructions executable on a computer stored thereon, the instructions comprising:
weighting key performance indicators in accordance with weighted serviceability related design aspects for a product;
correlating the weighted key performance indicators with serviceability requirements for the products to generate weighted serviceability requirements;
calculating an overall level of realization for the weighted serviceability requirements as an overall serviceability score for the product; and
displaying the overall serviceability score on a display.

20. The computer-readable medium of claim 19, the instructions adjusting the overall serviceability score as a function of preceding or competing products.

21. The computer-readable medium of claim 19, the instructions displaying an impact that a serviceability requirement has on the overall serviceability score.

22. The computer-readable medium of claim 19, the product being a medical imaging device.
